(19) United States
(12) Patent Application Publication
(10) Pub. No.: US 2008/0084617 A1
(43) Pub. Date: Apr. 10, 2008

(54) Optical module of the optical mice

(75) Inventor: Wen-Chih Ho, Taipei (TW)

Correspondence Address: RABIN & Berdo, PC, 1101 14TH STREET, NW, SUITE 500, WASHINGTON, DC, 20005, US

(73) Assignee: LIGHTING COSMOS TECHNOLOGIES, INC., Taipei (TW)

(21) Appl. No.: 11/543,935

(22) Filed: Oct. 6, 2006

(51) Int. Cl. G02B 17/00

(52) U.S. Cl. 359/726

(57) ABSTRACT

An optical module for an optical mouse utilizes the optical theory to provide the light signals as coordinates enabling the optical mouse to offer smoother response and precise tracking. The light coming from a light-emitting device forms the image through multiple transmissions, refractions and reflections, and the image reflects on a light signal acquisition device to provides the coordinates for the displacement of the optical mouse.

### BACKGROUND OF THE INVENTION

I. Field of the Invention

An optical module that is applied to the optical mouse is designed to acquire the light signals that form the image. The present invention refers especially to an optical module that can collimate light from the light source into reflective light by refraction and reflection so as to assure the optical mouse of smooth response and precise tracking on almost any transparent and even surface. The optical mouse with the optical module of the present invention become easier to operate and offers user-friendly convenience.

II. Description of the Prior Art

Because of employing the optical module as the interface to retrieve the image by the coordinates, the optical mouse can be built to be lightweight and have a compact size to offer a smoother response and precise tracking on almost any surface. They thus eventually replaced the mechanical trackball mouse. The optical mouse usually utilizes two encoder sets that output the serial logical signals to perform the logic operation of X-axis and Y-axis for displacement on the contact surface.

With reference to FIG. 1, which is a sectional view of an optical module of the prior art, the optical module 10 mainly comprises a 1^{st} lens 101, a 1^{st} reflecting portion 102, a 2^{nd} reflecting portion 103, a refracting portion 104 and a 2^{nd} lens 105. It also comprises a light-emitting device 106, which is installed near the 1^{st} lens 101 and serves as the light source, and an image retrieval device 107, which is installed above the 2^{nd} lens 105. In terms of the light source, the light emitting diode (LED) is the most adopted one among various light-emitting devices. This optical module 10 projects the LED light on the image capture facet A for retrieving a clear image to drive the displacement of an optical mouse. The light-emitting device 106 emits the light source light F that produce the light beam. The refractions and reflections of the light source light F are also shown in FIG. 1: the light source light F enters the 1^{st} lens 101 for being projected on the 1^{st} reflecting portion 102 and transferred into the 1^{st} reflected light beam F1; the 1^{st} reflected light beam F1 is projected on the 2^{nd} reflecting portion 103 and transferred into the 2^{nd} reflected light beam F2; the 2^{nd} reflected light beam F2 enters the refracting portion 104 and transfers into the refractive light beam F3; the refractive light beam F3 is projected onto an image capture facet A, which may be the surface of a desk on which an optical mouse is placed, to form an irradiation area F4. When the irradiation area F4 covers the image capture facet A, the latter is illuminated to a level that facilitates the image retrieval: the image capture facet A must be of rugged surface (see the enlarged portion of FIG. 1), and the irradiation area F4 is to receive the light source light at an included angle of 20˜35 degrees; the light source light is blocked by the concavity A1 on the rugged surface causing the umbra A11; the image retrieval device 107 retrieves the image composed of umbra A11 via the 2^{nd} lens 105. The said image retrieval also relates to logic operations by the electronic components. And, this is how the user can move the cursor with an optical mouse to latch onto an icon on the screen and click it to execute a function. This optical module 10 mainly utilizes the refraction and reflection to change the direction of the LED light so as to form an irradiation area F4 covering an image capture facet A of rugged surface where the light is blocked by the concavity A1 causing the umbra A11. The image composed of umbra A11 serves as the base of the logic operations. The image retrieval device 107 succeeds in retrieving the image composed of umbra A11 (see the mesh graph B of light signals in FIG. 1) as the lightness of the irradiation area F4 contrasts sharply to the umbra. According to FIG. 1, the image capture facet A is actually a surface where the user operates the mouse. Should it be the smooth surface of a glass or acrylic, there would be no concavity A1 causing the umbra A11 nor image composed of umbra A11. Under such circumstances, the image retrieval device 107 would fail to retrieve the image as there would be no contrast of the umbra A11 to the lightness of the irradiation area. Consequently, the user would fail to move the cursor with an optical mouse to latch onto an icon on the screen and click it to execute a function. It is thus understood that the optical mouse with this optical module 10 cannot be utilized on a smooth surface.

The “Optical Image Retrieval Method” of Taiwan Patent No. 1230359 refers to another application of the optical module of the prior art where an image sensor retrieves the image through refractions and reflections by a spectroscope: the light-emitting device emits in the vertical direction a light axis that enters a transparent media to reach an image contact surface, which is beneath the transparent media; and, the image formed on the image contact surface is projected to a spectroscope for multiple refractions so as to assure the optimum image retrieval. This application focuses on reducing the phase error as it employs a spectroscope for the light axis to refract at one single spot between the light-emitting device and the image sensor.

### SUMMARY OF THE INVENTION

The main objective of the present invention is to provide an optical module that assures the optical mouse of smoother response and precise tracking on almost any smooth surface.

The optical module of the present invention is a miniature one-piece module that can be installed in an optical mouse. It comprises several lenses, several reflecting portions and a spectroscope, and functions with a light-emitting device and a light signal acquisition device. The light from a light source transmits and refracts to transfer into a vertical coaxial light beam that is projected to an image capture facet where the uneven surface causes different reflections forming the light signals (beam spots). The light signals acquisition device acquires the light signals while they refracted at a lens. Even the smooth surface of glass has invisible pores causing different reflections to form the light signals that can be received by a light signal requisition device. Therefore, the optical module of the present invention can assure the optical mouse of smoother response and precise tracking on a transparent and smooth surface.

Desirable features of the present invention will be better understood from the detailed description and drawings that follow, in which various embodiments of the disclosed invention are illustrated by way of example.

### BRIEF DESCRIPTION OF THE DRAWINGS

FIG. 1 is a sectional view of the optical mouse of a prior art.

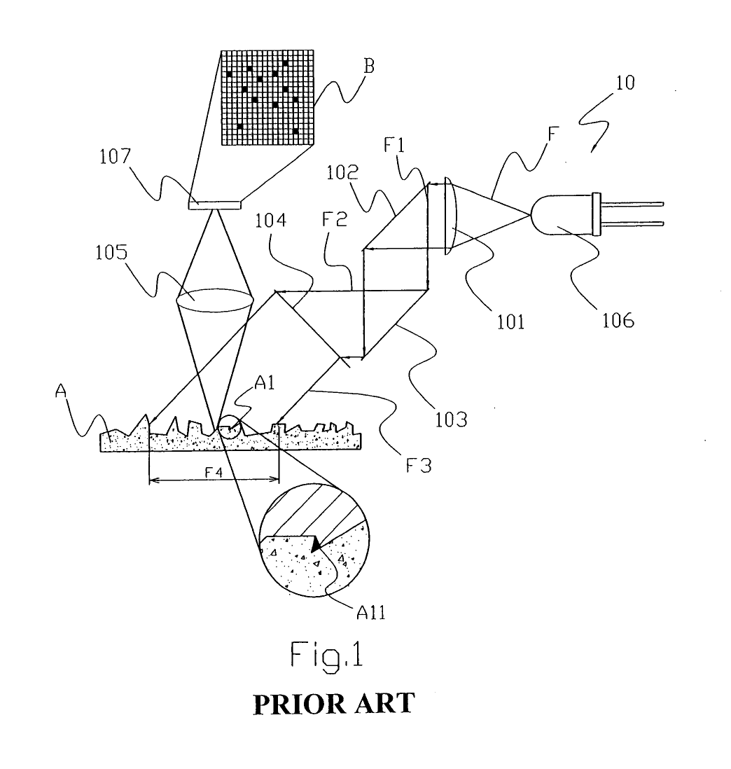

FIG. 2 is a sectional view of the optical module of the present invention.

FIG. 3 is a sectional view showing how the optical module of the present invention forms an image by the light signals.

FIG. 4 shows a preferred embodiment of the present invention.

FIG. 5 shows the optical module of the present invention installed in an optical mouse.

### DESCRIPTION OF THE PREFERRED EMBODIMENT

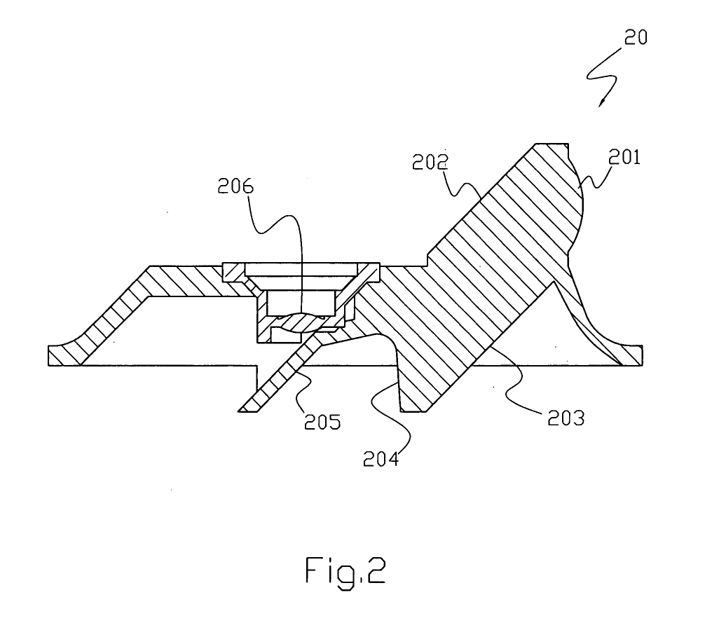

With reference to FIG. 2, which is a sectional view of the optical module 20 of the present invention, the optical module 20 comprises a 1^{st} condensing lens 201, a 1^{st} reflecting portion 202, a 2^{nd} reflecting portion 203, a 2^{nd} condensing lens 204, a spectroscope 205 and a lens 206. This optical module 20 is to provide light from a light source (not illustrated in FIG. 2) that transmits, refracts and reflects. As shown in FIG. 2: the 1^{st} reflecting portion 202 tilts against the 1^{st} condensing lens 201 at a proper angle and distance so that the light source light can reflect at the 1^{st} reflecting portion 202 after it enters and leaves the 1^{st} condensing lens 201; the 2^{nd} reflecting portion 203 and the 1^{st} reflecting portion 202 are formed with a proper interval that the light source light from the 1^{st} reflecting portion 202 reflects at the 2^{nd} reflecting portion 203; the 2^{nd} condensing lens 204 and the 2^{nd} reflecting portion are formed at a proper included angle that the light source light from the 2^{nd} reflecting portion 203 can be collimated by the ₂nd condensing lens 204 into a thin beam of parallel rays; the spectroscope 205 and the 2^{nd} condensing lens 204 are formed with a proper interval that the beam of parallel rays transferred by the 2^{nd} condensing lens 204 can reflect at the image capture facet A.

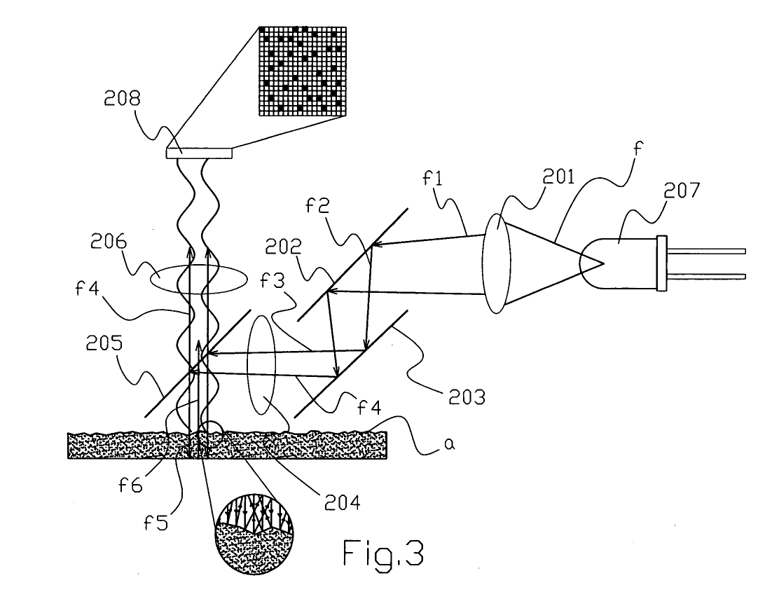

With reference to FIG. 3, which shows how the optical module of the present invention transfers the light signal into an image, it is a light-emitting device 207 (e.g. a light emitting diode with wavelength of 680 nm˜950 nm or a laser diode) that emits the light source light f through orthogonal or side projection. The path of the light source light f is as follows: the light source light f shall converge on the 1^{st} condensing lens 201 into a 1^{St} parallel light beam f1 that travels to the 1^{st} reflecting portion 202 and reflects a 1^{st} reflected light f2 thereat; the 1^{st} refractive light f2 shall travel to the 2^{nd} reflecting portion 203 and reflects a 2^{nd} reflecting light beam f3 thereat; the ₂nd reflecting light beam f3 travels to the 2^{nd} condensing lens 204 where it is collimated into a thinner light beam, the 2^{nd} parallel light beam f4. Furthermore, the 2^{nd} parallel light beam f4 immediately projects to the spectroscope 205 where it reflects at 80˜90 degrees and transfers into a 3^{rd} refractive light f5. The 3^{rd} refractive light f5 reflects at the image capture facet a and transfers into a reflective light beam f6. Under the circumstances, the beam spots (as shown in the mesh graph of FIG. 2) are formed and pass through the lens 206 that the light signal acquisition device 208 can acquire them in whole. It is also shown in FIG. 2 that the design of the 1^{st} condensing lens 201, 1^{st} reflecting portion 202, 2^{nd} reflecting portion 203 and 2^{nd} condensing lens allows the light source f converging into a thin light beam (the 1^{st} refracting light f1, the 2nd reflecting light f2). The 2^{nd} condensing lens 204 collimates the thin light beam into a parallel light beam f4 that can be transferred by the spectroscope into vertically downward reflected light (the 3^{rd} refractive light f5 and the reflective light beam f6). The beam spots are thus formed. With reference to the enlarged portion of FIG. 3, the 3^{rd} refractive light f5, reflective light beam f6, lens 206, light signal acquisition device 208 and mage capture facet a are in coaxial vertical alignment. And, in order to gather the light beam for projection, the image capture facet a has uneven surface that produces different reflections to form the beam spots. With the lens 206, the light signal acquisition device 208 can effectively receive any beam spots (which form the image) whether the image capture surface A is smooth or uneven. In other words, the mouse with the optical module of the present invention can retrieve the image from the surface of any materials.

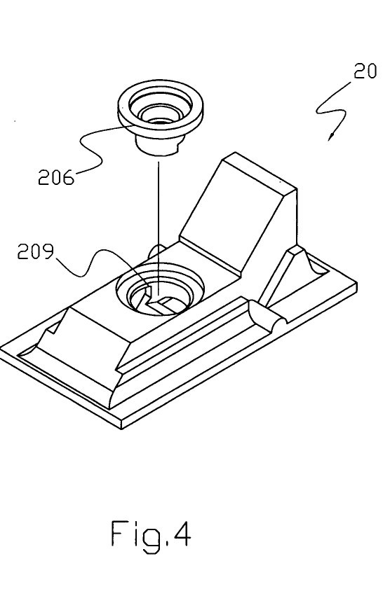

With reference to FIG. 4, which shows a preferred embodiment of the present invention, the lens 206 is a separate part installed in a holding portion 209 formed on the top of the optical module 20. The design of the holding portion 209 not only allows the optical module 20 to accommodate different lenses to meet any requirements, but also drastically reduces the molding cost and elevates the production effectiveness.

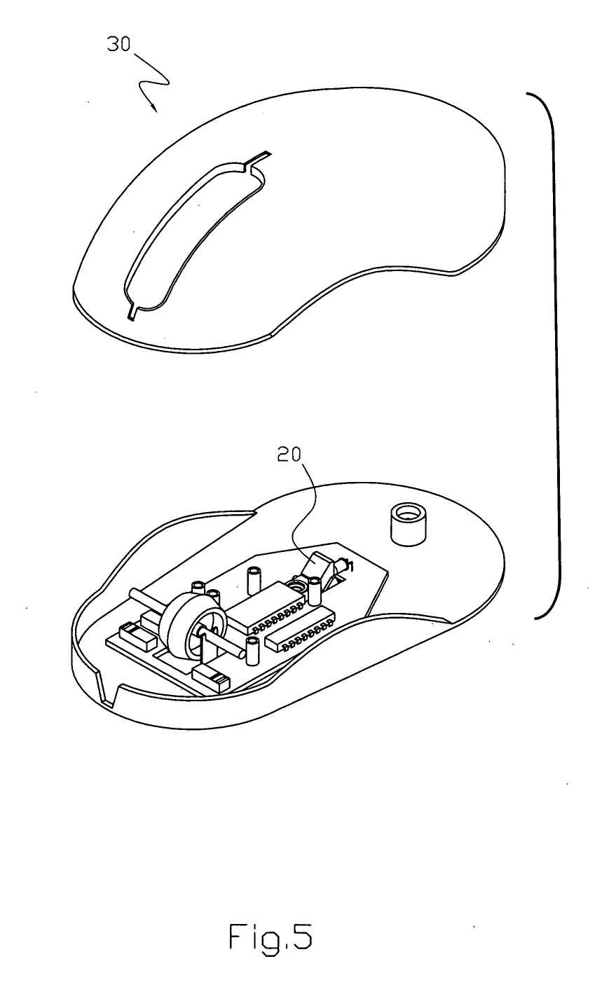

With reference FIG. 5, the optical module 20 of the present invention is installed in a mouse 30 as a position feedback system.

It is understood from the foregoing description that the present invention is an integral unit of lens, refracting lens and spectroscope where light from a light source can transfer into coaxial refractive and reflective lights by refraction and reflection. This integral unit allows the light signals vertically reflecting in the same axial direction that allows the light signal acquisition device to acquire them in whole. Under the circumstances, the beam spots can always form the image whether the image capture surface is transparent and smooth or not. Consequently, the optical mouse that has the optical module of the invention offers incredibly smooth, precise tracking.

To sum up, the present invention achieves successfully to provide an optical module that assures the optical mouse of smoother response and precise tracking on a transparent, smooth surface.

New characteristics and advantages of the present invention covered by this document have been set forth in the foregoing description. Understanding is sought however, that the drawings are for the purpose of illustration only and not intended to be a definition of the limits of the present invention. Changes in methods, shapes, structures or devices may be made in details without exceeding the scope of the invention by those who are skilled and knowledgeable in the field.

1. An optical module for use in an optical mouse, that utilizes refraction to produce beam spots indicating coordinates, the beam spots from light source light emitted by a light source, of a light-emitting device, through refraction and reflection, and acquired by a light signal acquisition device for identifying the image the optical module comprising:
a 1^{st} condensing lens, through which the light source light is collimated into a 1^{st} parallel light beam;
a 1^{st} reflecting portion angled with respect to the 1^{st} condensing lens to once reflect the 1^{st} parallel light beam to obtain 1^{st} reflected light;
a 2^{nd} reflecting portion, positioned with respect to the 1^{st} reflecting portion, to further reflect and the 1^{st} reflected light to obtain 2^{nd} reflected light;
a 2^{nd} condensing lens, positioned to collimate the 2^{nd} reflective light into a 2^{nd} parallel light beam;
a spectroscope, positioned with respect to the 2^{nd} condensing lens, to reflect the 2^{nd} parallel light beam reflecting vertically 3^{rd} reflective light, which reflects on an image capture facet and transfers back to and through the spectroscope as refracted light beam; and
a lens directing the refracted light to a light signal acquisition device for acquisition thereby.

2. The optical module of claim 1, wherein several condensing lens, several refracting portions, the spectroscope and the lens are an integral unit.

3. The optical module of claim 1, wherein several condensing lens, several reflecting portions and the spectroscope are an integral unit, a holding portion is formed on the top of the spectroscope to hold a lens.

4. The optical module of claim 1, wherein the light-emitting device is being a light emitting diode (LED).

5. The optical module of claim 4, wherein the wavelength of the LED is 680 nm˜950 nm.

6. The optical module of claim 1, wherein the light-emitting device is of orthogonal projection.

7. The optical module of claim 1, wherein the light-emitting device is of side projection.

8. The optical module of claim 1, wherein the light-emitting device is a laser diode.
